(19) United States
(12) Patent Application Publication
(10) Pub. No.: US 2003/0102844 A1
(43) Pub. Date: Jun. 5, 2003

(54) Automatic selfcharging power tools

(76) Inventor: Rudolph Bailey, Dover, DE (US)

Correspondence Address: Rudolph Bailey, 938 Shank Rd., Dover, DE, 19904, US

(21) Appl. No.: 10/301,951

(22) Filed: Nov. 22, 2002

Related U.S. Application Data
(60) Provisional application No. 60/336,023, filed on Nov. 24, 2001.

(51) Int. Cl. H02J 7/00

(52) U.S. Cl. 320/114

(57) ABSTRACT

A means for charging the battery of a battery powered tool or device automatically, as said device is used is disclosed. A battery operated device, such as a cordless power tool, can have its battery re-charged without using a AC plug-in type battery charger. This can be accomplished by installing a DC charging component, as a permanent part of the said device. The said charging component is installed in such a manner that the same motor that operates the said device, also energizes the said charging component. The power generated by said charging component, is then transmitted to said battery via a voltage regulating device. The process thus mentioned eliminates the need for a separate charging device for normal operation. This makes said tool or device more convenient to use, thus eliminating the gradual loss of power associated with conventional cordless power tools. This device will also save time and money to consumers. Another aspect of this invention is the establishment of a standardize, universal battery system which will create uniform battery standards world-wide for industries.

### BACKGROUND

This version of the invention is concerned with the field of battery operated power tools: such as reciprocating saws, miter saws, circular saws, electric drills, etc. More specifically, this version of the invention is concerned with battery operated tools that incorporate a built-in charging mechanism, that charges said batteries as said tools are being used. These tools will not depend on an external charging source for normal usage's. This invention also introduces a 6-volt universal re-chargeable battery system, in order to standardize re-chargeable batteries used in said cordless power tools. This represents an improvement over the existing products.

### PRIOR ART

A variety of cordless tools are available in the market place, however they depend on an external charger to refurbish the batteries. While many of these devices offer a variety of voltage and power options, they suffer from many disadvantages such as the inability to maintain a steady source of power: For example, as you use them they get weaker and weaker. Some tools offer a second battery that would replace the first battery when it becomes too weak. This means that there is an additional cost associated with a second battery that the consumer must absorb. In addition to that, there is the inconvenience associated with having to change the battery in the middle of a job. This could mean climbing down from a height and walking to a remote location to get the second battery from a charger. In a work environment, this could result in loss of time and productivity. However, in some instances one may have to use a cordless tool because no electrical power is available at the work site, in that case, one would be limited in what work could be performed with the cordless tools that are presently available in the market-place. There would be no way to recharge the batteries in that situation. Another problem with the previously mentioned tools is the high cost of said batteries, mainly because each manufacturer sets various standards for its batteries; therefore the consumer is forced to pay whatever the manufacturer charges.

What is needed therefore to overcome the referenced disadvantages of the available battery operated tools, is the provision of a device to re-charge the batteries of said tools as they are being used. Additionally a standardizes universal re-chargeable battery system is needed that can used by all manufactures. This would allow the consumer the option to shop for the best price. The said battery re-charging device should be simple to manufacture, and easily incorporated into said tool design, in a way that is practicable and beneficial to the user.

### DISCUSSION OF THE PRIOR ART

The present version of the invention would eliminate all of the above-mentioned problems, because with my invention, there would be no need to recharge the batteries in said tools. Many attempts have been made to design various recharging devises to make recharging the batteries easier, but they all seem to fall short of their intended goal, as they all require an AC outlet to do the recharging. Unlike my invention that does not require any external recharging source for normal use. Please reference U.S. Pat. No. 4,677,363, Apparatus For Storing And Charging a Rechargeable Electric Tool, issued to Lawrence E. House II; William H. O'Connor on Jun. 30, 1987. U.S. Pat. No. 5,998,965 Direct Plug-in Power Tool Using Single Pair Of Contacts For Both AC And DC Currents, issued to Vito J. Carlucci; Harold R. Taylor, on Dec. 7, 1999. U.S. Pat. No. 3,924,097 Stand For Charging An Electrical Tool and The Combination Of This Stand With Such A Tool, issued to Alvis R. Knowles; Harold S. Foster on Dec. 2, 1975. U.S. Pat. No. 4,438,483 Utility Handling and Charging Component Means Therefore, issued to Koehler Manufacturing Co. on Mar. 20, 1984.

As illustrated by the background art, efforts are continuously being made in an attempt to develop devises to improve the recharging of battery-operated tools. No prior effort, however, provides the benefits attendant with the present invention. As such, it may be appreciated that there is a continuing need for a new and better way to recharge the battery for cordless power tools.

The present invention achieves its intended purposes, objects, and advantages through a new, useful and unobvious combination of methods, steps and component elements that supplies the recharging process automatically as the said tool is being used.

### SUMMARY

The present version of the invention, which will be described in greater detail hereinafter relates to the field of battery-operated tools and their charging devises. More specifically, this version of the invention is concerned with battery operated tools employing automatic self charging components; consisting of a motor drive assembly and a internal charging mechanism that recharges the battery as the tool is being used: Thereby eliminating the need for the standard plug in type battery charger for normal operation and usage's. Described briefly, according to a typical embodiment, my invention presents an improvement to existing cordless power tools by incorporating a charging mechanism as a permanent part of said tools. My invention also supplies a standard universal re-chargeable battery system. The said system will cause all battery used in said cordless power tools, to be made to the same standards: therefore the price of said batteries will come down.

My invention therefore is distinguished from the prior art in this particular combination of its structures for the functions specified. In order that a detailed description of the invention may be better understood and that the present contribution to the art can be more fully appreciated, additional features of the invention will be described thereinafter. It should be appreciated by those skilled in the art that the conception and the disclosed specific methods and structures may be readily utilized as basis for modifying or designing other devices for carrying out the same purpose of the present invention. It should be realized by those skilled in the art that such equivalent methods and structures do not depart from the spirit and scope of the invention. In this respect, before explaining of at least one embodiment of the invention in detail, it is to be understood that the invention is not limited in its application to the details of construction, and to the arrangements of the components set forth in the following description or illustrated in the drawings, nor to the specific tools represented in the present application. The invention is capable of other embodiments and of being practiced and carried out in various ways. It is also to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the purposes of the present invention.

Furthermore, the purpose of the foregoing abstract is to enable the US Patent and Trademark Office and the public generally, and especially the scientist, engineers, and practitioners in the art who are not familiar with patent or legal terms or phraseology, to determine quickly from a cursory inspection the nature and essence of the technical disclosure of the application. The abstract is neither intended to be limiting as to the scope of the invention in any way.

Accordingly, it is an object of my version of the invention to provide a low-cost easy to manufacture, and easy to market self-charging cordless power tool. A further object of my version of the invention is to provide an easy to use and versatile automatic self-charging cordless power tool. A final but very significant object of the invention is to provide a lightweight cordless tool that works as close as possible to a plug-in type power tool, with all the advantages of being cordless, and that will be a pleasure to use by craft people and the general public as well.

For a better understanding of the invention, its operating advantages and the specific objects attained by its uses, references should be made to the accompanying drawings and descriptive matter in which there is illustrated a preferred, and alternate embodiment of the invention. Many other beneficial results can be attained by applying the disclosed invention in a different manner or by modifying the invention within the scope of the disclosure. Accordingly, other objects an a fuller understanding of the invention may be understood by referring to the summary of the invention and the detailed description of the preferred, and alternate embodiments in addition to the scope of the invention illustrated by the accompanying drawings.

### BRIEF DESCRIPTION OF THE DRAWINGS

The foregoing and other objects, features, and advantages of the inventions, will become more fully understood from the following description of the preferred and alternate embodiments of the inventions, as illustrated in the accompanying drawings in which reference characters refer to the same parts throughout different views. The drawings are not necessarily to scale emphasis is instead being placed upon illustrating the principles of the inventions.

FIG. 1 is an elevation view of a 18-volt self-charging cordless screw gun or drill in accordance with the present version of the invention. The view shows the top half of the housing removed so that the internals can be seen

FIG. 1A is an elevational view of a proposed 6-volt universal battery arrangement, with ranges of 6 to 36-volts in 6-volt increments; or any other equivalent desired voltage.

FIG. 2 is a cut-away plan view of a 24-volt self-charging cordless reciprocating saw, illustrating charging mechanism and wiring arrangement.

FIG. 3 is a perspective view of a 12-volt self-charging battery powered circular trim saw, in accordance with the present version of the invention.

FIG. 3A is a sectional view and wiring schematic of the above mentioned circular saw, in accordance with the present version of the invention.

FIG. 4 illustrates a front and end elevation and a wiring schematic for a 36-volt self-charging battery operated compound miter trim saw.

FIG. 5 is an elevational view of a proposed 6-volt universal battery charger and tester.

FIG. 6 is a elevational view of an alternate embodiment self-charging battery operated hammer drill.

### DRAWING REFERENCE NUMERALS

30 Screw Gun Housing

32 Drill Chuck

34 18-volt Battery(B1, B2, B3)

35 Battery Case

36 Shaft Collar

38 20-volt DC Motor

40 Positive Wire With Voltage Regulating Device

41 Negative Lead Wire

42 Motor Generator Drive Assembly

43 Trigger

44 18-volt DC Motor

45 Battery Case Lock

46 Air Vent

50 Knurled Chuck-spindle

51 AC/DC Conventional Battery Charger

52 Knurled Generator-spindle

53 Generator Locking Screws

54 Drill Chuck

55 Spindle Locking Screws

56 Hammer/Drill Indicator

57 Drill Handle Bar

58 Re-chargeable Battery

59 Drill Motor Assembly

61 Negative Lead Wire

62 Positive Lead Wire

63 Trigger

64 Generator Unit

68 26-volt DC Generator

69 6-volt Re-chargeable Battery

70 Generator Pulley

71 Positive Charging Connection

72 Drive Belt

73 Negative Post and Charging Connection

74 Motor Pulley

76 Positive Wire and Voltage Regulator

78 Motor Drive Shaft

79 Voltage Regulator

80 24-volt Battery (B1, B2, B3, B4)

82 24-volt Drive Motor

84 36-volt Battery (B1, B2, B3, B4, B5, B6)

85 Battery Case

86 36-volt DC Motor

87 Battery Case-lock

88 38-volt DC Motor

89 Trigger

90 Motor Pulley and Belt

91 Generator Pulley and Belt

92 Miter Saw Blade

93 Negative Lead Wire

94 Positive Lead Wire

96 Blade Guard

98 Housing Guard

99 Pulley Guard End-cap

100 Switch

101 Battery Case

102 12-volt Battery (B1, B2)

103 Switch

104 12-volt DC Motor

105 Trigger

106 14-volt DC Generator

107 Adjustable-arm Balance Weight

108 Movable Blade Guard

109 Trigger

110 Handle

111 Terminal Post with Permanent Pin

112 Circular Saw Blade

113 Battery Terminal with Removable Pins

114 Motor-shaft Pulley Assembly

115 Positive and Negative Output to Device

116 Generator-shaft Pulley Assembly

117 Inside-corner Tab-blocks

118 Drive Belt

120 Positive Re-cycle Wire and Voltage Regulating Device

121 Negative Lead Wire

122 Voltage Regulating Device

148 Positive Charger Post

150 Negative Charger Post

152 Battery Voltage Test Push Button

154 Volt-meter

### DESCRIPTION OF THE PREFERRED EMBODIMENTS DESCRIPTION

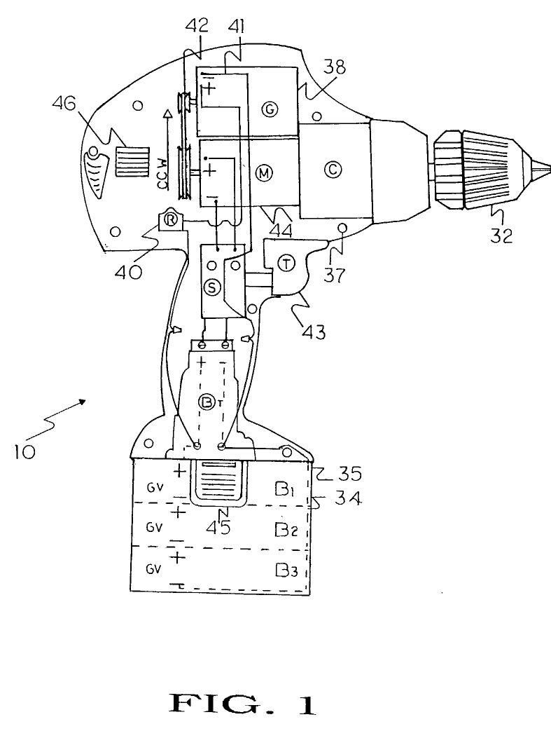

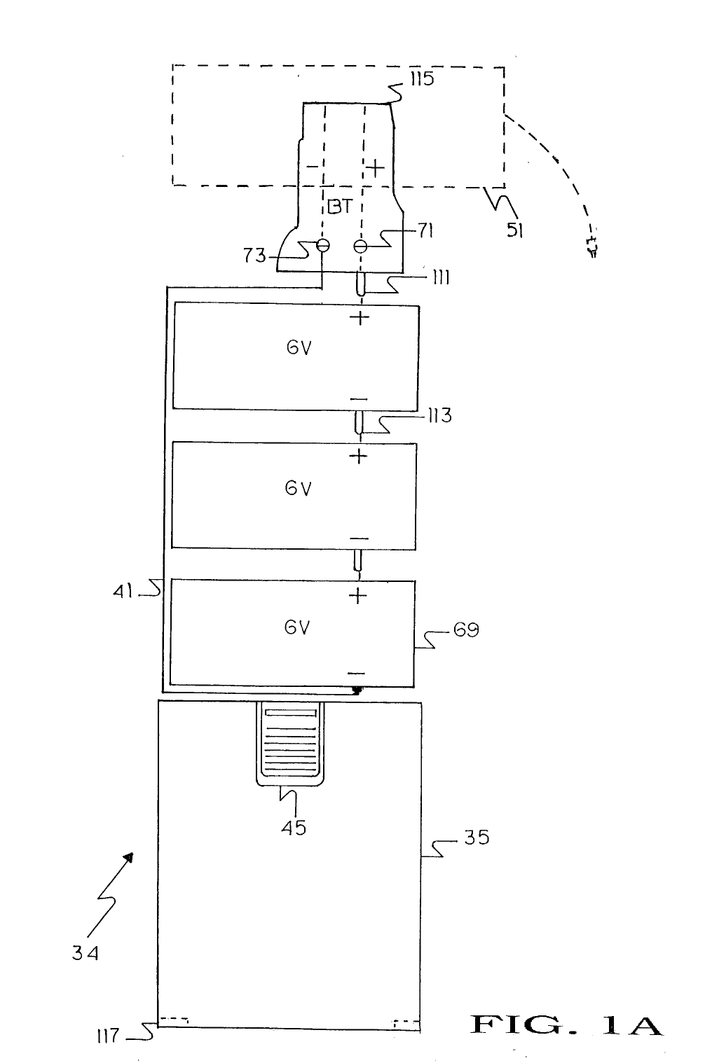

Referring now to the drawings and in particular to FIG. 1 where in there is illustrated a typical embodiment of a 18-volt battery operated automatic self-charging screw gun 10. The present version of the invention 10 is constructed of material and components that are light weight, durable, and resistant to corrosion and oxidization, such as plastic, aluminum, carbon steel, various composite materials or a combination thereof: including the possibilities of conductive polymers, or any standard materials for a conventional cordless drill or screw-gun. The differences are as follows: Motor 44 has drive shaft with double extension, a second motor 38 is installed over motor 44, and used as a generator. Motor 38 should be 2-volts higher than motor 44. Generator and motor-pulley and belt assembly 42 is also installed, motor 44 is wired to operate in a counter-clockwise rotation as viewed from rear of drill, and voltage regulator 40 is also installed.

When trigger 43 is depressed, motor 44 is energized allowing device 10 to operate for its desired purpose. Motor 38 is also set in motion by motor and generator drive assembly 42. The said process allows motor 38 to perform as a generator, thereby producing 2-charging-volts to battery 34, via voltage regulator 40. For example if battery 34 is 18-volts then motor 38 must be 20 -volts, and motor 44 18-volts. Battery 34 is shown in 6-volt sections (B1, B2, B3) and connected to give 18-volts. Battery case 35 is used secure battery 34 to said drill or screw-gun 10. The previously mentioned charging force of 20-volts enters at BT contact, via voltage regulator 40. However any number of battery sections or just a single unit may work. As motor 44 is operated in a counter-clockwise rotation the other end of shaft extension will be operating in a clockwise rotation as viewed from front of device 10 (For battery connection detail refer to FIG. 1A)

Referring now to FIG. 1A therein is illustrated a typical embodiment of a 6-volt universal re-chargeable battery system 34. The present version of the invention 34 is constructed of materials and components, that will allow the said battery to be re-charged by a generator type device, as they are connected together in series to increase volts. The said batteries can also be re-charged, by a conventional plug-in type AC to DC charger (such as device 51 shown in phantom lines) when separated as individual 6-volt sections, or when connected in series. The rest of the component parts of the said universal system 34, is comprised of light weight materials that are durable, and resistant to corrosion and oxidization, such as plastic, or equivalent materials or alloys.

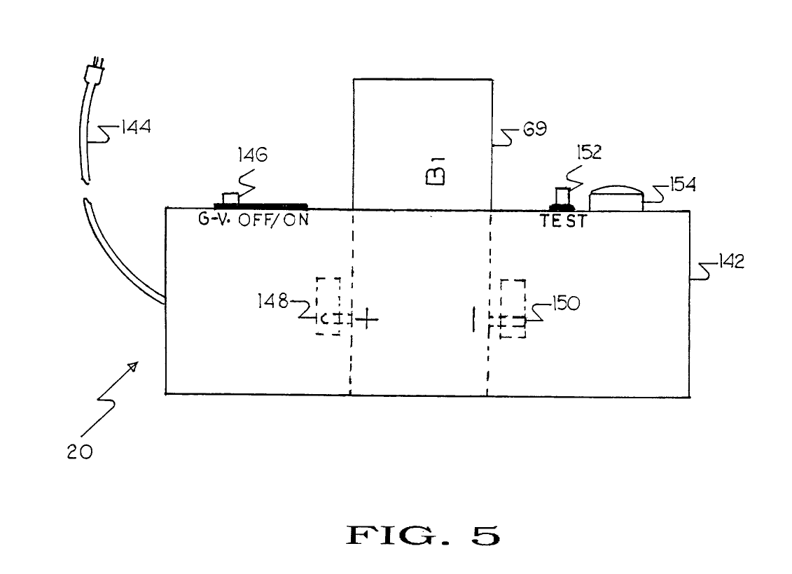

The said system 34, is comprised of a battery terminal post 115, and the desired 6-volt battery sections 69, and outer case 35 which includes locking mechanism 45. The said terminal post 115 has a permanent receptacle pin 111, and terminal screws 73(positive pole), and terminal screw 71(negative pole). A 6-volt battery, section 69 has positive internal connection at top, and negative internal connection a bottom. Battery section 69 is supplied with two removable pins 113. Both pins are needed when external charger 20 (FIG. 5) is being used.

FIG. 1A shows a 18-volt system, however any voltage arrangement can be achieved from 6-volts and up, in 6-volt increments. To install battery, remove positive pin from all sections of battery 69 as illustrated by FIG. 1. Mate negative to positive as shown. Remove negative pin from last section of battery 69 and install negative wire 41 as shown. Connect other end of wire 41 to screw 73 as shown. Install case 35 and secure lock. Internal tabs 117 prevents crimping of wire 41.

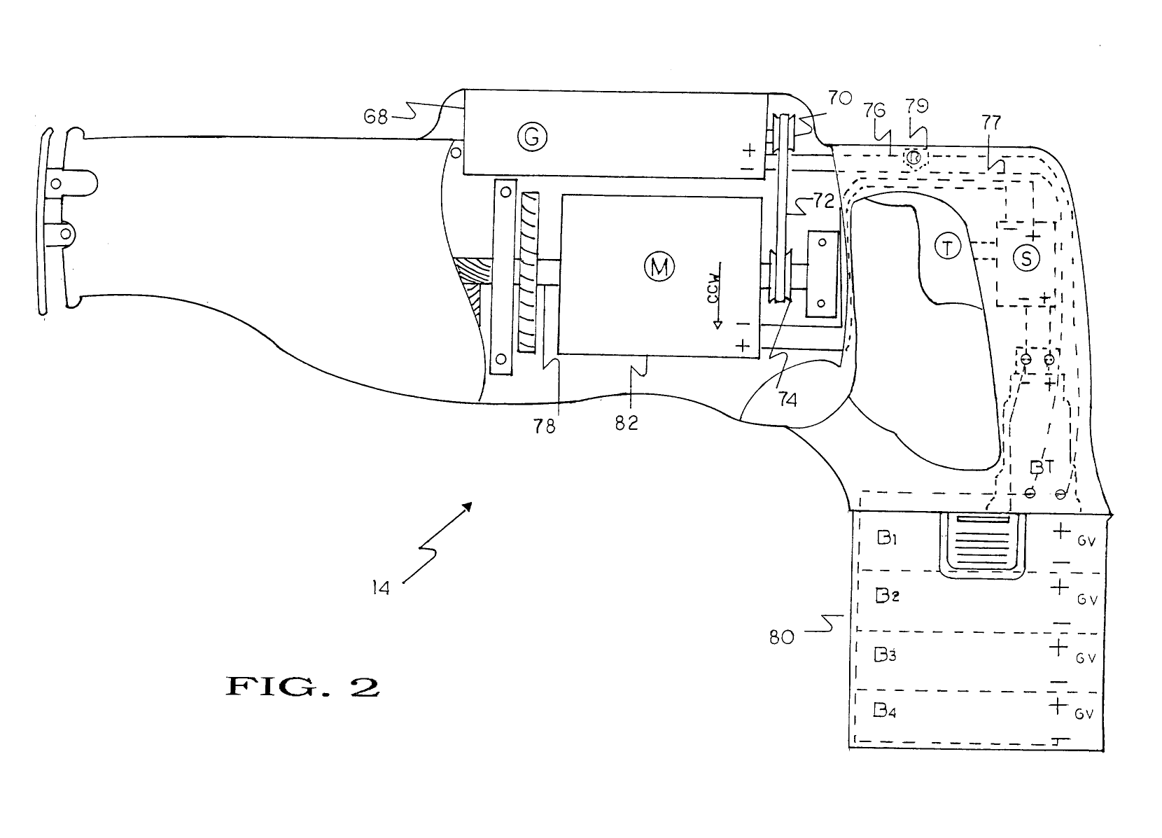

Referring now to FIG. 2 wherein there is illustrated a typical embodiment of a 24-volt battery operated self-charging reciprocating saw 14. The present version of the invention 14 is constructed of standard materials for a conventional battery operated reciprocating saw, incorporating the following modifications: Motor 82 has shaft with double extension 78, with space to install pulley 74 at back end of motor 82, a 26-volt DC motor 68 which acts as a generator, and voltage regulator 79.

When trigger 89 is depressed motor 82 which is wired to operate in a counter-clockwise rotation is set in motion (this rotation is viewed from trigger to motor). Drive belt 72 will drive motor 68 in a counter-clockwise rotation. Motor 68 will act as a generator by sending 26-volts to battery 80 via voltage regulator 79. This process will in turn re-charge battery 80 as long as device 14 is in use (battery 80 is in four 6-volt sections B1, B2, B3, B4 and connected to give 24-volts). The charging volts enters at BT connections. Any number of sections or just one battery may work. Charging volts may also enter at any other appropriate connection.

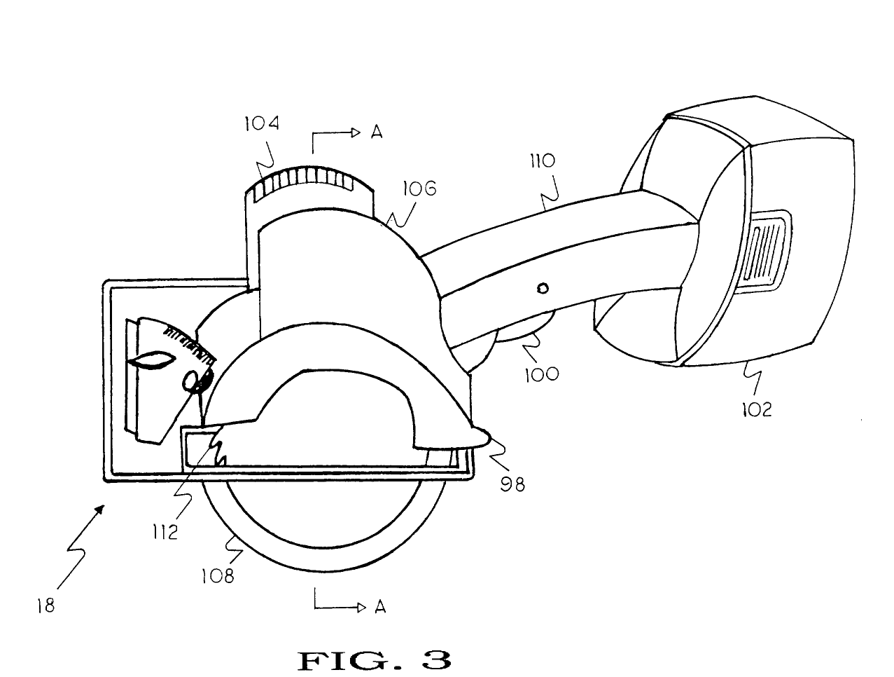

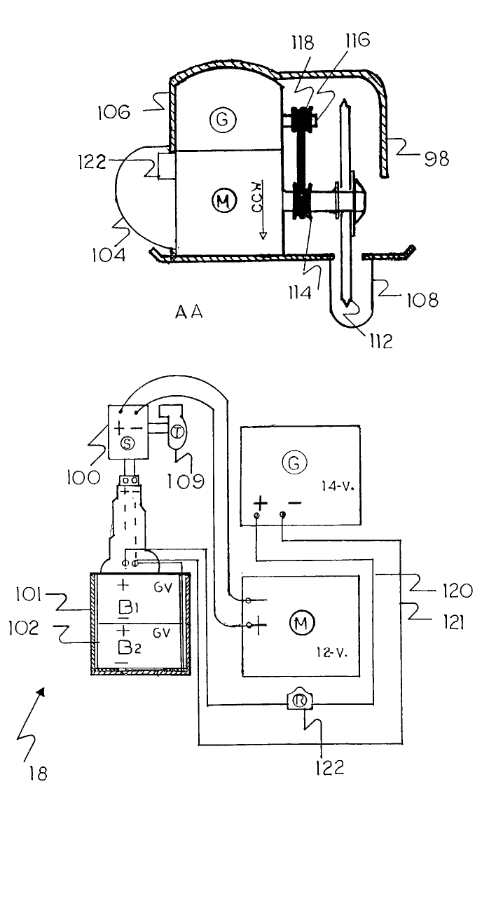

Referring now to FIG. 3 wherein there is illustrated a typical embodiment of a 12-volt self-charging battery operated circular trim saw 18. The present version of the invention 18 is made of standard materials for a conventional cordless circular saw, with the following modifications, which is better illustrated in conjunction with FIG. 3A: drive motor 104 has drive shaft extending enough to allow installation of pulley 114, between motor 104 and cutting blade 112. A 14-volt motor 106 is installed on top of motor 104, and used as a generator, a voltage regulator 122 is also installed as shown, guard 98 is extended to protect pulley-drive-belt-assembly 116 and blade 112.

When trigger 109 is depressed motor 104 which is wired to operate in a counter-clockwise rotation, is set in motion, causing blade 112 to perform its desired cutting action. Motor 106 is also placed in motion by drive belt 118. This said mention process enables generator 106 to deliver the necessary charging volts to battery 102 via voltage regulator 122. This process eliminates the need for an external charging source for normal operation of device 18.

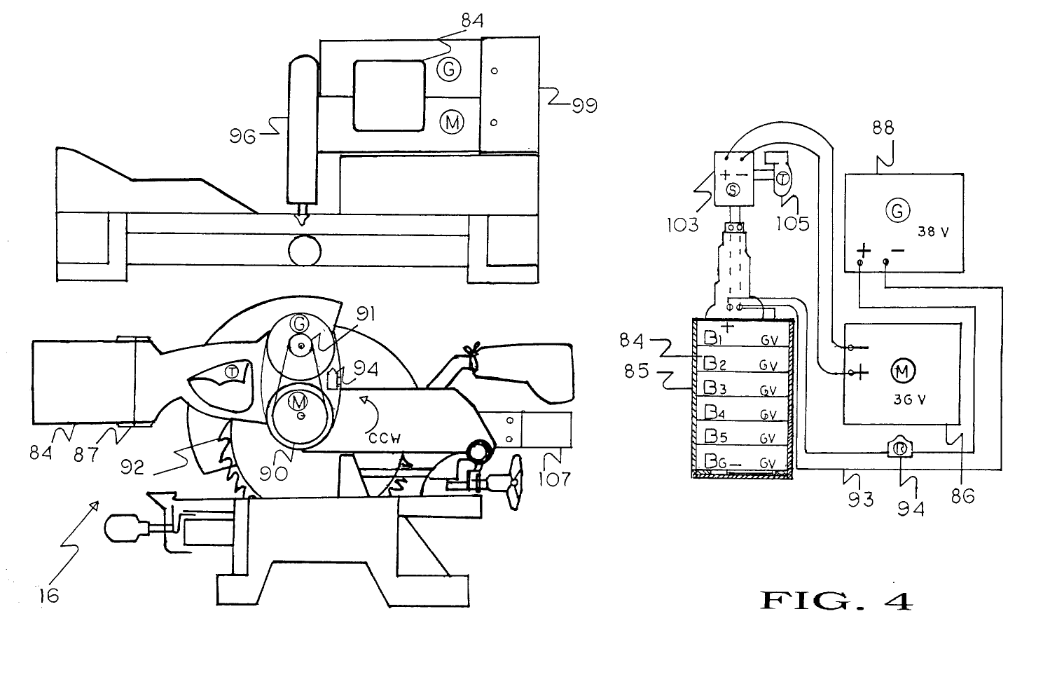

Referring now to FIG. 4 wherein there is illustrated a typical embodiment of a 36-volt cordless self-charging compound miter saw 16. The present version of the invention 16 is constructed of standard materials for a cordless compound miter saw incorporating the following modifications: a 38-volt DC motor 88 is installed above 36-volt drive motor 86 and functions as a generator. Drive motor pulley 90, and generator drive and belt assembly 91, and voltage regulator 94, and end cap 99, and arm balance weight 107, is also installed as shown.

When trigger 105 is depressed 36-volts goes to drive motor 86, thereby causing cutting action by blade 92. Generator 88 is also set in motion by drive assemblies 90 and 91, thereby sending the desired charging volts to battery 84 via voltage regulator 94. This process eliminates the need for an external charging source for normal operation of device 16.

Referring now to FIG. 5 wherein there is illustrated an optional 6-volts DC universal battery AC type charger 20. The present version of the invention 20, is made of materials that are light weight, durable and resistant to corrosion and oxidization, such as plastic, alloy metals or any other suitable materials. The invention 20 consist in the main housing 142, of a conventional volt meter 154, and conventional 110-volt AC to 6-volt DC charger components. Included also are positive and negative poles 148 and 150 respectively, a on/off switch 146, and a test push button 152, and AC receptacle cord 144.

When using previously mentioned self-charging battery powered tools for the first time, it is recommended that the batteries are fully charged, before installing them into said tools. Although they will be charged at the factory, batteries can become week, during shipping and storage. Charging can be accomplished by using a conventional battery charger, as illustrated in FIG. 1A, or by using a 6-volt universal battery charger 20, as illustrated in FIG. 5. Since each 6-volt universal battery section is supplied with both positive and negative pins installed, one would only need to insert said battery into said charger, as shown in FIG. 5. Next slide switch 146 to the on position. Next press test push button 152, and read the voltage on meter 154. If said battery is fully charged, simply remove it and repeat said process with remaining sections. If said batteries are not fully charged, simply leave said battery on charger until full voltage is achieved. Next install battery to tool as illustrated by FIG. 1A.

### DESCRIPTION OF ALTERNATE EMBODIMENT DESCRIPTION

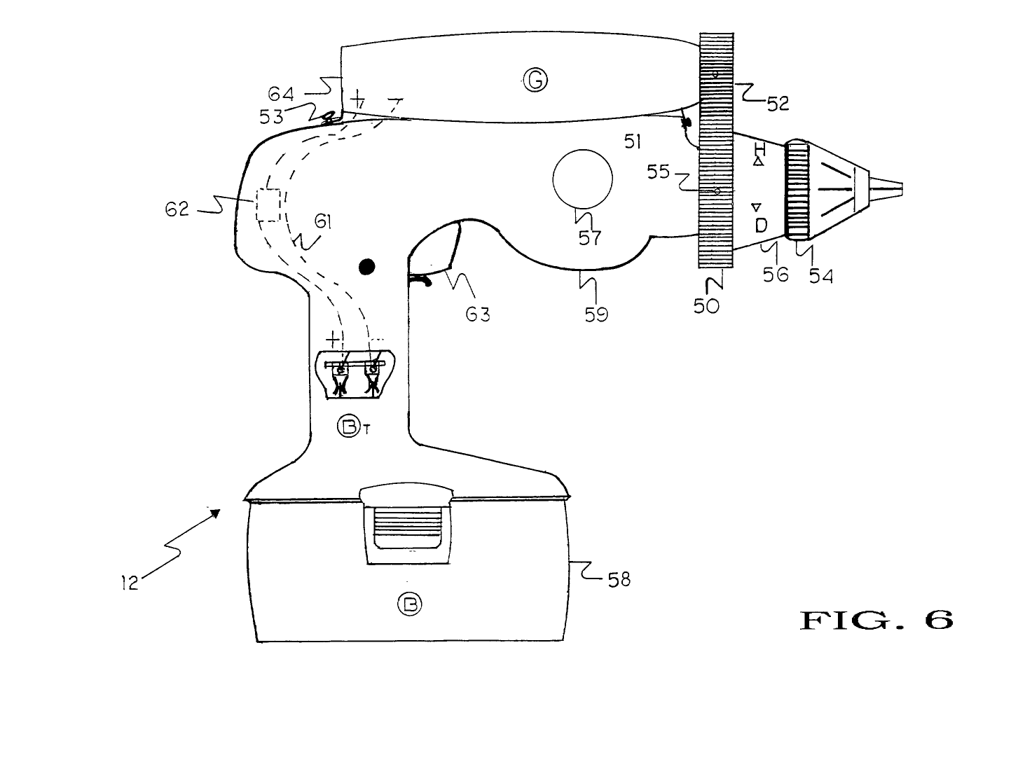

Referring now to FIG. 6 wherein there is illustrated as alternate embodiment of a self-charging battery operated hammer drill 12. The present version of the invention 12 is constructed of materials and components for a conventional cordless hammer drill, with the following modifications: a generator 64 of voltage high enough to charge a battery that will be used to operate said tool, is mounted on said drill as indicated by FIG. 6. A knurled collar 50 is also installed on chuck collar in such a way as to engage knurled collar 52 which is attached attached to generator 64. Set Screws 55 secure said knurled collars in place. A voltage regulator 62 is also installed as shown.

When trigger 63 is depressed chuck 54 is set in motion causing device 12 to perform its desired functions. Collar 50 in turn causes collar 52 to set generator 64 in motion, thereby causing the desired charging volts to enter battery 58 via voltage regulator 62. The said action eliminates the need for an external charging source for device 12 as long as said device is in operation.

### Ramificatin Conclusion and Scope of Invention

From the foregoing, it will be readily understood by persons skilled in the art than an improved self-charging battery operated device has been provided. The invention is relatively simple and easy to manufacture, yet affords a variety of uses. While my description contains many specifications, these should not be construed as limitations on the scope of the invention, but rather as an exemplification of the preferred embodiment thereof. For example, any number, type or voltage of rechargeable batteries could be chosen rather than that which is specified in the present application. The foregoing is considered as illustrative only of the principles of the invention. Further, since numerous modifications and changes will readily occur to those skilled in the art, it is not desired to limit the invention to the exact construction and operation shown and described; accordingly all suitable modifications and equivalents may be resorted to, falling within the scope of the invention. Although this invention has been described in its preferred form with a certain degree of particularity, it is understood that the present disclosure of the preferred form has been made only by way of example, and numerous changes in the details of construction and combination and arrangement of parts may be resorted to without departing from the spirit and scope of the invention.

1. Independent claims for self-charging battery operated power tools or device
What I claim is the independent means to create continuous DC power within a battery powered device as said device is used comprising:
(a) DC motor with means to operate a DC charging component and said device at the same time
(b) charging component of volts/amps sufficient to charge said battery and wired to
(c) voltage regulating device and connected to
(d) battery of sufficient volts/amps to operate said motor whereby said charging component charges said battery as said device is operated whereby said device is housed in appropriate casing.
Independent claims for 6-volt universal re-chargeable battery system
What I claim is a means to create desired DC voltage from universally standardized 6-volt components of volts/amps sufficient to operate cordless power tools or device comprising:
(a) battery terminal plug-in type post with secondary connections and
(b) 6-volt battery sections with internal positive and negative poles and mating pins for connections and
(c) negative pole wire connector lead to said terminal post whereby appropriate battery sections are inter-connected to achieve desired volts/amps as they are enclosed in casing cover and attached to appropriate device.
